(19) United States
(12) Patent Application Publication
(10) Pub. No.: US 2014/0151405 A1
(43) Pub. Date: Jun. 5, 2014

(54) RESERVOIR MODULE FOR PUMP DISPENSER

(71) Applicant: Nigel Kelly, Rye Brook, NY (US)

(72) Inventor: Nigel Kelly, Rye Brook, NY (US)

(21) Appl. No.: 14/235,212

(22) PCT Filed: Jul. 26, 2012
(86) PCT No.: PCT/US12/48247

§ 371 Date: Jan. 27, 2014

Related U.S. Application Data
(60) Provisional application No. 61/512,377, filed on Jul. 27, 2011.

(51) Int. Cl. A61J 1/14

(52) U.S. Cl. CPC A61J 1/1406
USPC 222/183; 222/541.1; 222/81; 222/153.1

(57) ABSTRACT

The current invention discloses a fluid reservoir module for holding a fluid that may be used in a fluid dispenser. The fluid reservoir has a base, a reservoir body enclosing an internal void, and at least one removable tab attached to the reservoir body. The reservoir body is disposed on the base and the removable tab blocks inserting the reservoir body into a dispenser body. By detaching the removable tab(s), the reservoir body may be inserted into the dispenser body. Simultaneously, a fluid transfer structure, preferably a hollow spike, may penetrate a frangible part of the reservoir so that fluid in the reservoir may be extracted. The fluid in the reservoir is preferably pre-loaded. The current invention is particularly useful for dispensing small amounts of fluid, such as eye drops, but it may also be scaled up for larger volumes.

### CLAIM OF PRIORITY

This application claims the priority of U.S. Ser. No. 61/512,377 filed on Jul. 27, 2011, the contents of which are fully incorporated herein by reference.

### FIELD OF THE INVENTION

The current invention relates to a reservoir module for use with a fluid dispenser. More particularly, the current invention relates to a reservoir module that may be separated from and inserted into a dispenser body used for delivering fluids, including eye drops or ear drops.

### BACKGROUND OF THE INVENTION

This patent application fully incorporates by reference the contents of U.S. Ser. No. PCT/US2012/038560 with the title “Indexable Fluid Dispenser” filed on May 18, 2012 and U.S. Ser. No. PCT/US2012/038564 with the title “Fluid Dispenser,” both by the same inventor.

It is common practice to prescribe eye drops for ophthalmic treatments. Consequently, it is desirable to develop apparatus and devices that may help the application of ophthalmic fluids. In particular, there is a great need for novel designs for reservoirs that may be used in ophthalmic fluid dispensers, as well as other types of pumps and delivering devices. First, it is preferred that the fluid to be delivered is kept in a hermetically sealed reservoir to ensure that the fluid maintains its sterility. To achieve this goal, the reservoir may be prefilled before being sealed. Secondly, it is desirable that the reservoir may be attached to and detached from the other parts of the fluid dispenser, allowing more flexibility as to changing the fluid to be dispensed and the pump mechanism to be used.

A number of dispensers utilizing reservoirs that are integral parts of the dispenser have been disclosed. In some cases, the reservoirs are pre-filled with formulations. For example, U.S. Pat. No. 7,678,089 discloses a dispenser which uses an integral rigid vial containing the liquid to be dispensed. The rigid vial shown is disadvantageous, however, in that the seals which connect the various parts to form the vial are critical to maintaining the integrity of the fluid held therein. If any of the sealing surfaces is compromised or damaged, either during manufacturing, assembly, or transportation, the formulation may leak out of the dispenser or become contaminated.

In addition, U.S. Pat. No. 6,666,359 discloses a dispenser that is typical of single-use eye drop products, and is used as a complete device for delivering eye drops directly to the eye. The dispenser includes a twist-off top, which is removed prior to the dispensing of drops. This design, however, has the disadvantage that the dispenser can be used only once. Without any pumping mechanisms, this dispenser lacks flexibility as to how to direct the fluid to a user's eye.

In summary, various designs are known in the art, but their structures are distinctively different from the current invention. Moreover, the other inventions fail to address all of the problems solved by the invention described herein. One embodiment of this invention is illustrated in the accompanying drawings and will be described in more detail herein below.

### SUMMARY OF THE INVENTION

The current invention discloses a fluid reservoir module for holding a fluid, comprising: a dispenser body, a reservoir body enclosing an internal void, the reservoir body having a top portion and a bottom portion, wherein the reservoir body may be inserted into the dispenser body. The fluid reservoir module may further include a base, wherein the reservoir body is disposed on the base and the bottom portion of the reservoir body is connected to the base. Moreover, the fluid reservoir module may further include at least one removable tab attached to the reservoir body, the removable tab blocks inserting the reservoir body into the dispenser body, and detachment of the removable tab allows the insertion of the reservoir body into the dispenser body.

The reservoir module itself is not able to dispense drops. It may be coupled with a pump dispenser in order to dispense the fluid in the reservoir. The internal void of the reservoir module may be pre-filled with fluid to be dispensed. To prevent contamination, the internal void is preferred to be hermetically sealed. In a “pre-loaded” or “partially assembled” state, the reservoir module mainly resides outside but attaches to the dispenser body. The removable tab(s) extends from the reservoir body, blocking the insertion of the reservoir body into the dispenser. There may be corresponding structures on the dispenser body that engage the removable tabs, making the blockade more secure.

The top portion of the reservoir body may include an upper neck encircling a neck hole, wherein the neck hole is sealed with a frangible membrane. After detachment of the removable tab or tabs, the reservoir body may be inserted into a dispenser. During the insertion, a fluid transfer mechanism attached to the underside of the dispenser may penetrate the frangible membrane sealing the internal void of the reservoir module so that the fluid in the internal void may be extracted. Preferably, the fluid transfer mechanism is a hollow spike with a through-hole. With the insertion of the reservoir body into the dispenser, the hollow spike penetrates into the internal void, fluidly connecting the internal void to the dispenser.

The current invention also covers fluid dispensers that incorporate the reservoir module herein disclosed. The dispenser may have a dispenser body that fits with the reservoir module. In particular, the dispenser body may have a bulkhead that separates the interior of the dispenser body into a lower chamber and an upper chamber, wherein the reservoir body may be inserted into the lower chamber and the upper chamber may house a pump mechanism. In addition, the dispenser body and the reservoir module may have corresponding engagement structures that allow the dispenser body and the reservoir body to be securely attached once the insertion is complete.

Preferably, a pump mechanism is housed in the upper chamber of the dispenser body. As would be appreciated, any suitable form of pump mechanism, or assisted drop delivery apparatus, could be used in the fluid dispenser, provided it is able to draw the fluid from the reservoir module and then dispense the formulation from the outlet.

The reservoir module and the pump dispenser disclosed by the current invention may be made with various processes. The preferred method for making the reservoir body is the “blow-fill-seal” (BFS) molding process. With the BFS process, the reservoir is made by joining together two pieces of container wall material, and then injecting fluid into the void. The preferred method for making the pump dispenser is by means of the injection molding process. Preferably, the pump dispenser body and the reservoir module are delivered to the user in the partially assembled state, with the neck of the BFS reservoir module registered into the pump dispenser, but with the frangible seal fully intact. A wide range of materials may be used to make the reservoir module and the pump dispenser. The preferred materials are thermoplastics including but not limited to: acrylics, polypropylene, polyethylene, and most other families of thermoplastic resins or co-polymers.

Preferably, the reservoir module is to be incorporated into fluid dispensers having miniature pumps and, particularly, pumps used for delivering eye drops or ear drops in small doses. However, the same reservoir and pump designs may also be scaled-up to deliver much larger doses. Moreover, the fluid dispensed may be any fluid or liquid. The fluid may be a pharmaceutical formulation, solution, gel, or suspension. The fluid may be delivered to the eye, ear, or any other targets.

In general, the present invention succeeds in conferring the following, and others not mentioned, desirable and useful benefits and objectives.

It is an object of the present invention to provide a fluid reservoir module that may be used to hold ophthalmic fluids such as eye drops.

It is an object of the present invention to provide a fluid reservoir module that is pre-filled.

It is an object of the present invention to provide a fluid reservoir module that is easy to make and easy to use.

It is an object of the present invention to provide a fluid reservoir module that is made with the BFS process.

It is an object of the present invention to provide a fluid reservoir module that is hermetically sealed and opened right before use.

It is an object of the present invention to provide a fluid reservoir module that may be inserted into a dispenser body after blocking structures are removed.

It is an object of the present invention to provide a fluid reservoir module that may be incorporated into a fluid dispenser.

It is an object of the present invention to provide a fluid reservoir module that may incorporated into different fluid dispensers using different pump mechanisms.

It is an object of the present invention to provide a fluid dispenser that is capable of delivering fluids such as ophthalmic solutions and ear drops.

It is an object of the present invention to provide a fluid dispenser that is capable of delivering a series of doses with repetitive dosing processes.

It is an object of the present invention to provide a fluid dispenser that incorporates a fluid dispenser module that is pre-filled, hermetically sealed, and pre-loaded to the dispenser body.

It is another object of the current invention to provide a fluid dispenser that may be used for different purposes.

It is still another object of the current invention to provide a fluid dispenser that is simple in structure and easy to manufacture.

It is yet another object of the current invention to provide a fluid dispenser that discharges a stream of fluid in a trajectory partly determined by gravity.

It is yet another object of the current invention to provide a fluid dispenser that is easy to use.

### BRIEF DESCRIPTION OF THE DRAWINGS

FIG. 1 shows a perspective view of the preferred embodiment of a fluid dispenser having a reservoir module, with the reservoir module shown in its “pre-loaded” state and prior to initial use.

FIG. 2 shows a side view of the preferred embodiment of the dispenser having a reservoir module, with the reservoir module shown in its “pre-loaded” state and prior to initial use.

FIG. 3 shows a top view of the preferred embodiment of the pump dispenser having a reservoir module, with the reservoir module shown in its “pre-loaded” state and prior to initial use.

FIG. 4 shows a side sectional view of the preferred embodiment of the dispenser having a reservoir module, with the reservoir module shown in its “pre-loaded” state and prior to initial use.

FIG. 5 shows a side sectional view of the reservoir module, with the reservoir module shown in its “pre-loaded” state and prior to initial use.

FIG. 6 shows a side sectional view of the reservoir module, with the reservoir module shown in its fully loaded state, and ready for use.

FIG. 7 shows a perspective view of the preferred embodiment of the dispenser having a reservoir module, with the reservoir module in its fully loaded state and the base part secured.

### DESCRIPTION OF THE PREFERRED EMBODIMENTS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

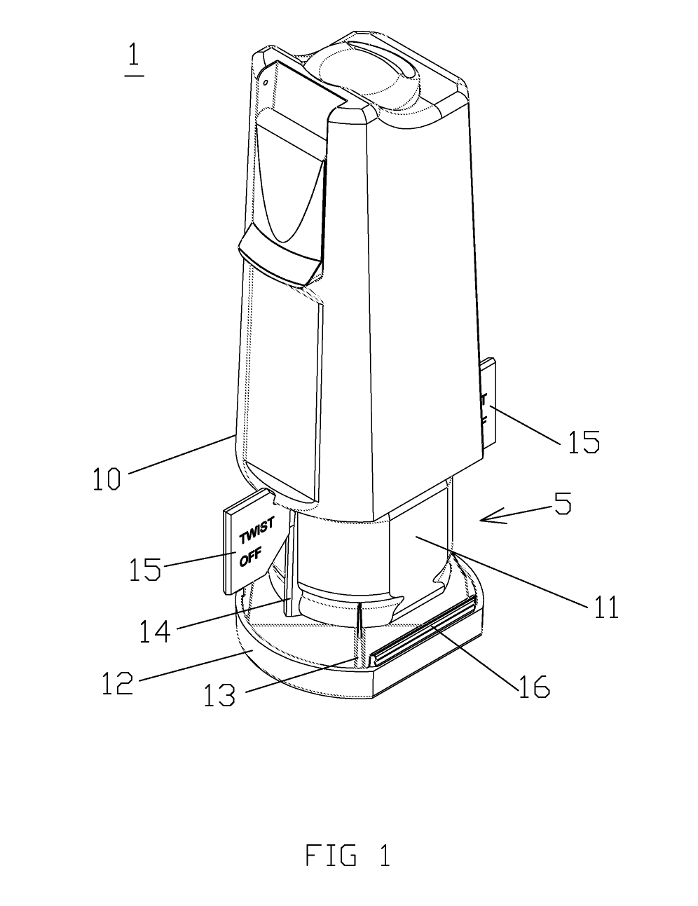

FIG. 1 shows a perspective view of the preferred embodiment of a fluid dispenser 1 having a reservoir module 5, with the reservoir module 5 shown in its “pre-loaded” state and prior to initial use. Shown in FIG. 1 is the fluid dispenser 1 having a dispenser body 10 and a reservoir module 5, the reservoir module including a base 12 and a reservoir body 11 having weld-seam protrusions 14. As shown in FIG. 1, the reservoir body 11 is disposed beneath the dispenser body 10, and held in place by two removable tabs 15. The base 12 is positioned under the reservoir body 11 and attaches to the reservoir body 11 by means of ribs 13. Upon removal of the removable tabs 15, the reservoir body 11 may be fully inserted into dispenser body 10. In addition, snapping tongue 16 resides on base 12 and snaps into a snapping tongue receiver (not shown) within dispenser body 10 when the reservoir body 11 is fully inserted.

The fluid dispenser 1 may be used for various purposes. The preferred use of the fluid dispenser 1 is to deliver eye drops to a human eye. The fluid dispenser 1 may be used in an up-right position, or it may be leaned forward to deliver a dose to a person whose eye is directly below the dispenser, as is typical with the use of dropper bottles, and the fluids discharged from the fluid dispenser 1 may be applied in a trajectory that ends up on a target, such as an eye. The fluid dispensed may be any fluid or liquid. The fluid may be a pharmaceutical formulation, solution, gel, or suspension. The fluid may be delivered to the eye, ear, or any other targets.

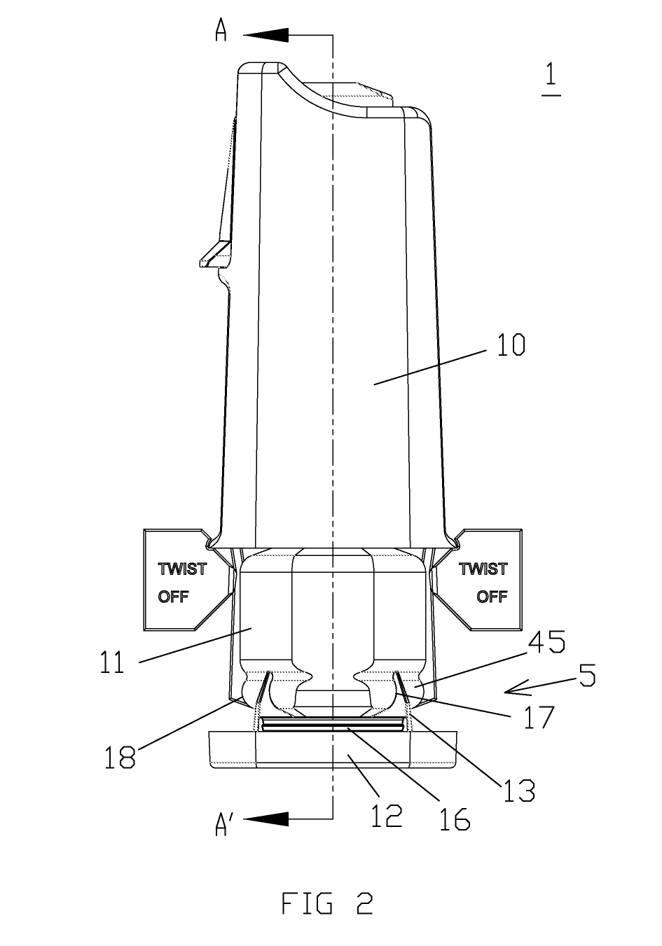

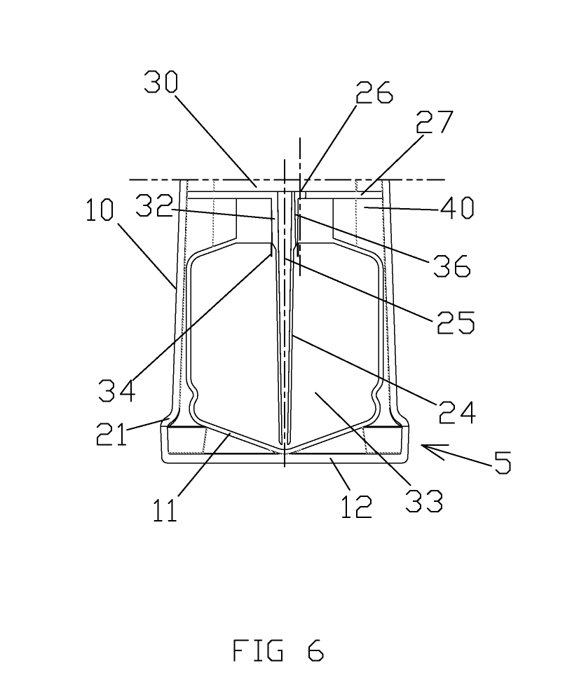

FIG. 2 shows a side view of the preferred embodiment of the fluid dispenser 1 having a reservoir module 5, with the reservoir module 5 shown in its “pre-loaded” state and prior to initial use. Shown in FIG. 2 is the fluid dispenser 1 having a dispenser body 10 and a reservoir module 5, the reservoir module including a reservoir body 11 and a base 12. As shown in FIG. 2, the reservoir body 11 is disposed beneath the dispenser body 10, and held in place by two removable tabs 15. The base 12 is positioned under the bottom portion 45 of the reservoir body 11 and attaches to the bottom portion 45 by means of ribs 13, the ribs 13 having a profiled inner form 17 which conforms with profiled surfaces 18 on the bottom portion 45 of the reservoir body 11. Markers A and A′ serve as indicators for sectional views of the dispenser and/or the reservoir module shown in FIG. 6.

It should be noted that the base 12 is not an indispensible structure for the reservoir module though it is preferred that base 12 is included. Base 12 provides a foundation onto which the reservoir body 11 and other structures such as the snapping tongue 16 may be positioned.

Without the base 12, the reservoir body 11 may be the structure at the bottom. In that case, it is preferred that the bottom portion 45 of the reservoir body 11 is enlarged so that it is not completely inserted into the dispenser body and serves as the supporting structure.

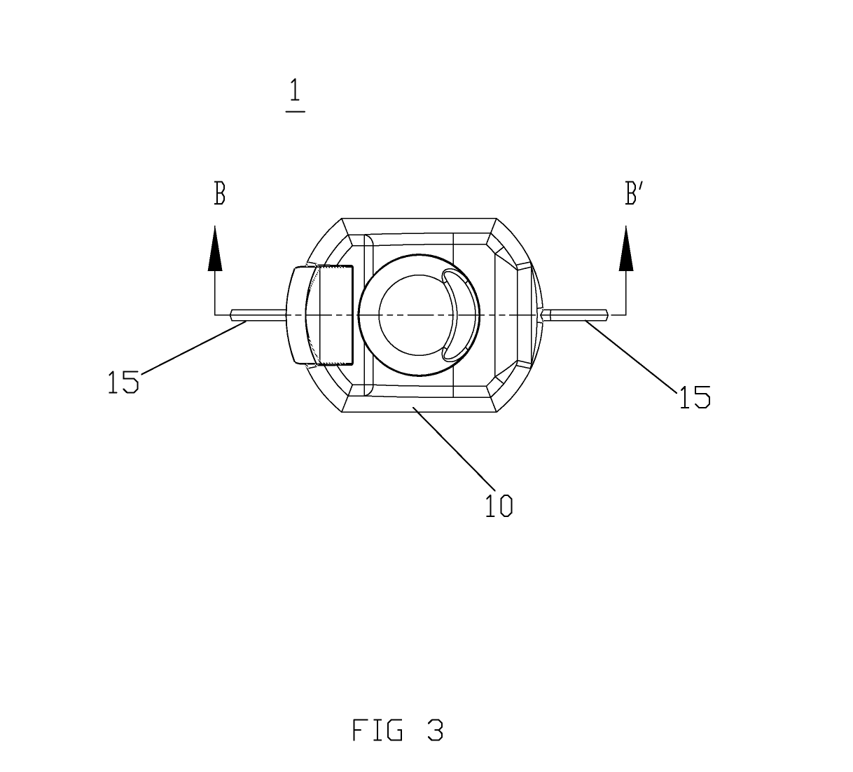

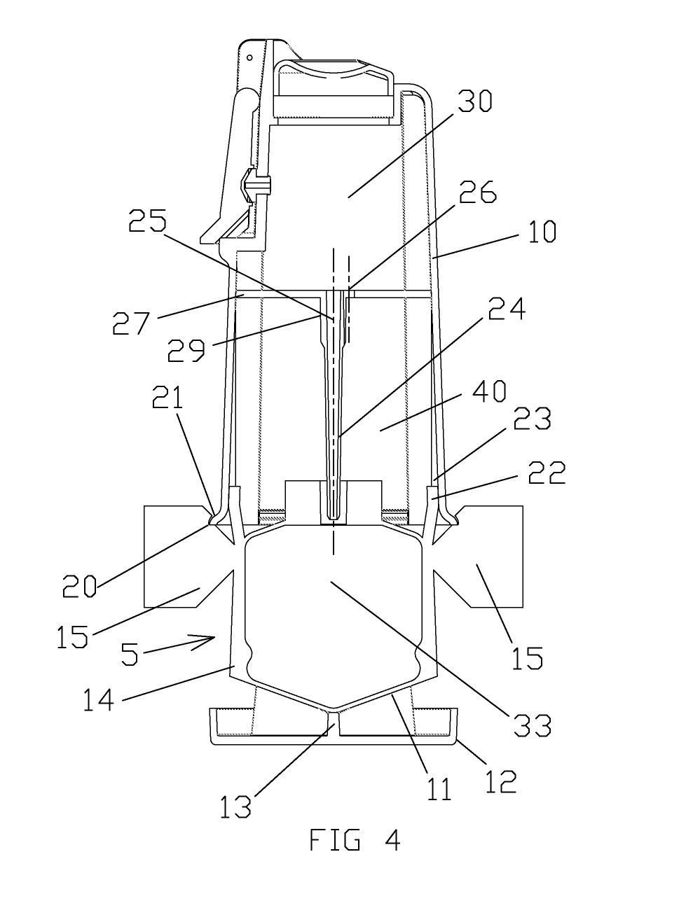

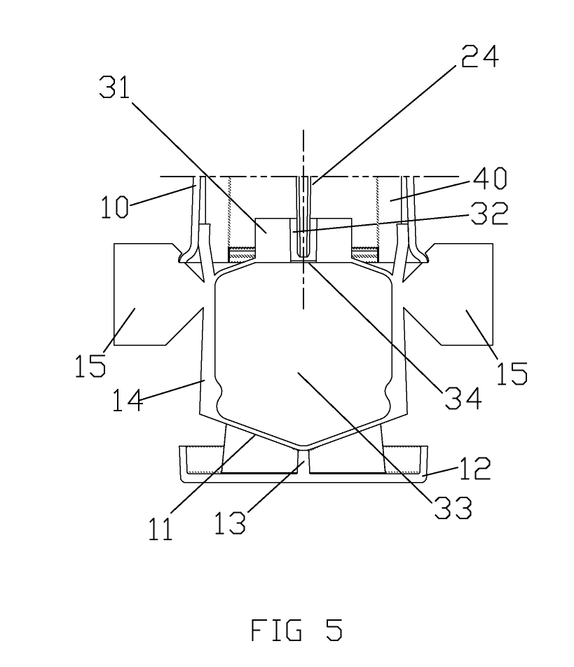

FIG. 3 shows a top view of the preferred embodiment of the fluid dispenser 1 having reservoir module, with the reservoir module shown in its “pre-loaded” state and prior to initial use. Shown in FIG. 3 are the dispenser body 10 and the removable tabs 15 of the reservoir module. Markers B and B′ serve as indicators for sectional views of the dispenser and reservoir module shown in FIGS. 4-5.

FIG. 4 shows a side sectional view of the preferred embodiment of the fluid dispenser 1 having a reservoir module 5, with the reservoir module 5 shown in its “pre-loaded” state and prior to initial use. The section is indicated in FIG. 3 by markers B and B′. Shown in FIG. 4 is the fluid dispenser 1 having a dispenser body 10 and a reservoir module 5, the reservoir module 5 including a reservoir body 11, a base 12, and ribs 13. The reservoir body 11 encloses an internal void 33. The dispenser body encloses an interior, which is divided by a bulkhead 27 into an upper chamber 30 and a lower chamber 40.

As shown in FIG. 4, the reservoir body 11 has weld-seam protrusions 14. These protrusions may be omitted if the reservoir body is not made from the BFS process or if proper steps are taken to eliminate such welding features. For the embodiment shown in FIG. 4, the weld-seam protrusions are connected to projecting arms 22. The projecting arms 22 are spring-loaded such that they maintain sliding contact with two pairs of retaining beads 23 residing in the dispenser body 10.

The removable tabs 15 have a notch 20 that engages with a block tip 21 on the dispenser body 10. Prior to use, tabs 15 are removed from the reservoir body 10 by a twisting action, and are then detached. The removal of tabs 15 permits the projecting arms 22 to slide upwards between retaining beads 23 to guide the reservoir body 11 into the lower chamber 40. After the reservoir body 11 is completely inserted, the base 12 engages the dispenser body 10 and the reservoir body 11 resides in the lower chamber. During the sliding engagement of the reservoir body 11 and dispenser body 10 the lower portion of the weld-seam protrusion 14 also enters the gap between the retaining beads 23 to provide further alignment.

The removable tabs 15 are used to block the insertion of the reservoir body 11 into the dispenser body 10. However, it should be noted that the removable tab is not an indispensible structure, nor is the number of removable tabs fixed. When there is no removable tab 15 included in the reservoir module, other structures may serve as the blocking mechanism. For example, without the removable tabs 15, the projecting arm 22 shown in FIG. 4 may be made from roughened materials or may have roughened surfaces facing the inner walls of the dispenser body 10. The substantial friction between the projecting arm 22 and the dispenser body wall may prevent the unwanted insertion of the reservoir body. Alternatively, there may be engaging mechanisms present on the projecting arm 22 and the dispenser body wall. For example, there may be semi-spherical protrusions on the projecting arm and corresponding sockets on the dispenser body wall. The protrusion-socket engagement may block the insertion of the reservoir body, while pushing forces exceeding a certain threshold may disengage the attachment and allow the insertion.

As shown in FIG. 4, a hollow spike 24 having a through hole 25 extends downward from the bulkhead 27. The upper end of the through hole 25 in the hollow spike 24 levels with the top of bulkhead 27. The upper portion 29 of the hollow spike 24 is positioned close to the bottom of the bulkhead 27, the upper portion having a bigger diameter than the other parts of the hollow spike 24. Through the bulkhead 27 and adjacent to the through hole 25 is a second hole 26, which continues downwards as a partial hole along the upper portion 29 of the hollow spike 24.

The upper chamber 30 above the bulkhead 27 may be used to accommodate a pump mechanism (not shown) which connects to the through hole 25 in the hollow spike 24. The through hole 25 may serve as an inlet for the fluid held in the internal void 33 to be supplied to any suitable form of pump, which provides the propelling forces to dispense the fluid through an outlet.

FIG. 5 shows a side sectional view of the reservoir module 5, with the reservoir module shown in its “pre-loaded” state and prior to initial use. The section is indicated in FIG. 3 by markers B and B′. Shown in FIG. 5 is part of the fluid dispenser 1 having a dispenser body 10 and a reservoir module 5, the reservoir module 5 including a reservoir body 11, removable tabs 15, a base 12, and ribs 13. The reservoir body 11 encloses an internal void 33, which defines the reservoir module's volumetric capacity. As shown in FIG. 5, the top portion of the reservoir body 11 has an upper neck 31 encircling a neck hole 32. The neck hole 32 is covered by a thin frangible membrane 34. When the frangible membrane 34 is intact, the internal void 33 is hermetically sealed. The hollow spike 24 is retained in position closely above the frangible membrane 34 in the pre-loaded state.

FIG. 6 shows a sectional view of the reservoir module 5, with the reservoir module shown in its fully loaded state, and ready for use. The section is indicated in FIG. 2 by markers A and A′. Shown in FIG. 6 is part of the fluid dispenser 1 having a dispenser body 10 and a reservoir module 5, the reservoir module 5 including a reservoir body 11 and a base 12. The reservoir body 11 encloses an internal void 33. The hollow spike 24 protrudes from the bottom side of the bulkhead 27, which separates the interior of the dispenser body 10 into a lower chamber 40 and an upper chamber 30 (not shown in FIG. 6). In the fully loaded state, as shown in FIG. 6, the reservoir body 11 is accommodated in the lower chamber 40, the base 12 is engaged with the lower end of the dispenser body 10, and in particular the blocking tip 21, and hollow spike 24 is inserted into the internal void 33 of the reservoir module 5.

During the insertion of the reservoir body 11 into the lower chamber 40, the frangible membrane 34 is pierced by the hollow spike 24. As shown in FIG. 6, once the lower tip 28 of the hollow spike 24 reaches the bottom of the internal void 33 of the reservoir body 11, the fluid in the internal void 33 may be extracted by pump mechanisms through the through hole 25 of the hollow spike 24. Simultaneous with the lower tip 28 of the hollow spike 24 reaching the bottom of the internal void 33 of the reservoir body 11, a vent path 36 is established through neck hole 32 and the second hole 26 on the bulkhead. The vent path 36 allows the internal void 33 of the reservoir body 11 to prevent a vacuum from forming within the internal void 33 as fluid is drawn from it by the pump mechanism. Any suitable form of pump (not shown), and as housed within the upper chamber 30, may connect with hole 26 to provide atmospheric venting to reservoir body 11.

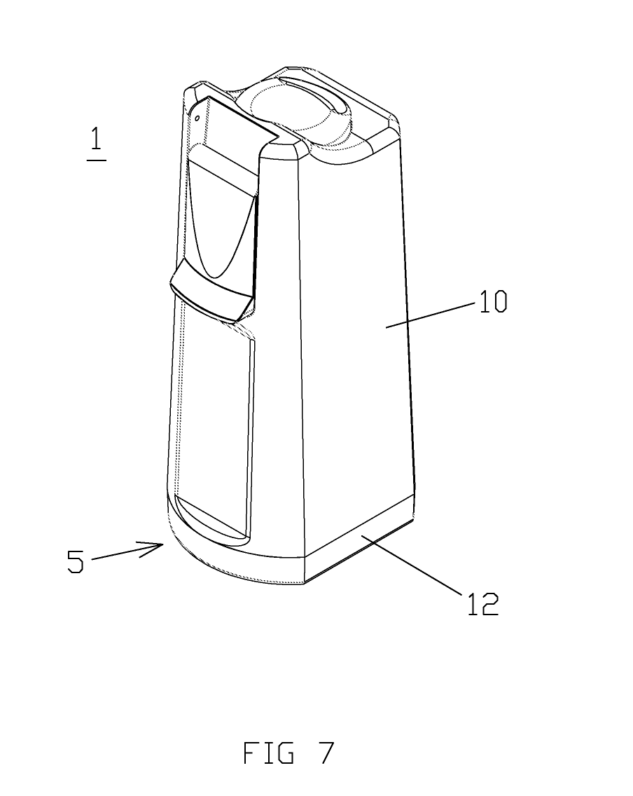

FIG. 7 shows a perspective view of the preferred embodiment of the fluid dispenser 1 having a reservoir module 5, with the reservoir module in its fully loaded state and the base part secured. Shown in FIG. 7 are the dispenser body 10 and the base 12 of the reservoir module. In this state, the dispenser is fully assembled (loaded) and ready to be used.

The dispenser body 10 and the reservoir body 11 may be made from the same or different materials including but not limited to metal, wood, and plastics such as but not limited to, polyethylene terephthalate (PET), polyethylene (PE), high-density polyethylene (HDPE), polyvinyl chloride (PVC), polyvinylidene chloride (PVDC), low-density polyethylene (LDPE), polypropylene (PP), polystyrene (PS), high impact polystyrene (HIPS) and polycarbonate (PC), or paperboard coated with a suitable waterproof coating, or some combination thereof. The preferred materials for the dispenser body 10 and the reservoir body 11 are plastics, including but not limited to: acrylics, polypropylene, polyethylene, and most other families of thermoplastic resins or co-polymers. Similarly, the various components of the fluid dispenser 1, including the components of the reservoir module 5, may be made from the same or different materials as the dispenser body 10 and reservoir body 11. Some components may have special requirements as to the property of the materials. For example, the frangible membrane may be made from a thin flexible plastic, such as cellophane.

As indicated above, the current reservoir module and dispenser incorporating the module may be used for many purposes and the embodiments may be any dimension that is suitable for the use of the dispenser. Preferably, the reservoir and dispenser are used for the delivery of ophthalmic fluids in small doses, such as 1 to 100 microliters per dose. The reservoir module may hold multiple doses of the fluid to be dispensed, with a preferred overall volume to be 100 microliters to 500 milliliters. Nevertheless, the reservoir module and the dispenser may be scaled up for dispensing large quantities of liquid.

Preferably, the reservoir module is pre-filled with the fluid to be dispensed and the dispenser, including the reservoir module, is provided to a user in a pre-loaded state. The user then may detach the removable tab 15, insert the reservoir module, and start using the dispenser. However, the dispenser may be provided to the user with the reservoir module already in a fully loaded condition.

The reservoir module may also be coupled with different kinds of pump mechanisms, as indicated above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A fluid reservoir module for holding a fluid, comprising:
a dispenser body; and
a reservoir body enclosing an internal void, the reservoir body having a top portion incorporating a frangible membrane and a bottom portion,
wherein the reservoir body is capable of being inserted into the dispenser body.

2. The fluid reservoir module of claim 1, further comprising a removable tab attached to the reservoir body, wherein the removable tab blocks inserting the reservoir body into the dispenser body, and removal of the removable tab allows the insertion of the reservoir body into the dispenser body.

3. The fluid reservoir module of claim 1, further comprising a removable tab attached to the reservoir body, wherein the removable tab blocks inserting the reservoir body into the dispenser body, and removal of the removable tab allows the insertion of the reservoir body into the dispenser body, and further comprising a base, wherein the reservoir body is disposed on the base and the bottom portion is connected to the base.

4. The fluid reservoir module of claims 1, further comprising ribs attached to the base, wherein the ribs are connected to the bottom portion of the reservoir body.

5. The fluid reservoir module of claim 1, further comprising ribs attached to the base, wherein the ribs are connected to the bottom portion of the reservoir body, and wherein the ribs have profiled inner forms, the bottom portion of the reservoir body has profiled surfaces, and the profiled inner forms match the profiled surfaces, allowing the reservoir body to fit to the ribs.

6. (canceled)

7. (canceled)

8. (canceled)

9. (canceled)

10. The fluid reservoir module of claims 1, further comprising a snapping tongue attached to the base.

11. (canceled)

12. (canceled)

13. A fluid reservoir module of claim 1, wherein
the reservoir body hermetically seals an internal void, the top portion of the reservoir body comprises an upper neck encircling a neck hole, the neck hole being sealed by the frangible membrane, wherein piercing the membrane breaks the hermetic seal of the internal void,
two removable tabs attached to the reservoir body, wherein the removable tabs block inserting the reservoir body into the dispenser body, and removal of the removable tabs allows the insertion of the reservoir body into the dispenser body; and
a snapping tongue attached to the reservoir body, wherein inserting the reservoir body into the dispenser body results in the snapping tongue engaging a snapping tongue receiver, affixing the reservoir body to the dispenser body.

14. The fluid reservoir module of claim 13, further comprising:
a base,
ribs attached to the base,
wherein the ribs have profiled inner forms, the bottom portion of the reservoir body has profiled surfaces, and the profiled inner forms match the profiled surfaces, allowing the reservoir body to fit to the ribs, the snapping tongue attaches directly to the base, and inserting the reservoir body into the dispenser body results in the snapping tongue engaging a snapping tongue receiver, affixing the reservoir body to the dispenser body.

15. (canceled)

16. A fluid dispenser, comprising:
a dispenser body enclosing an interior,
a bulkhead disposed in the dispenser body, dividing the interior into an upper chamber and a lower chamber,
a hollow spike attached to the bulkhead, the hollow spike enclosing a through hole,
a fluid reservoir module comprising:
a base,
a reservoir body enclosing an hermetically sealed internal void, the reservoir body having a top portion and a bottom portion, wherein the reservoir body is disposed on the base and the bottom portion is connected to the base, and
a removable tab attached to the reservoir body, wherein the removable tab blocks inserting the reservoir body into the lower chamber, and removal of the removable tab allows the insertion of the reservoir body into the lower chamber.

17. The fluid dispenser of claim 16, wherein the fluid reservoir module further comprises:
ribs attached to the base, the ribs having profiled inner forms,
wherein the bottom portion of the reservoir body has profiled surfaces, the ribs are connected to the bottom portion of the reservoir body, and the profiled inner forms match the profiled surfaces, allowing the reservoir body to fit to the ribs.

18. The fluid dispenser of claims 16, wherein the dispenser body has a blocking tip, and the blocking tip engages the removable tab, preventing inserting the reservoir body into the lower chamber.

19. The fluid dispenser of claims 16, wherein the top portion of the reservoir body comprises an upper neck encircling a neck hole, the neck hole being sealed by a frangible membrane, wherein inserting the reservoir body into the lower chamber results in the piercing of the frangible membrane by the hollow spike, allowing the through hole of the hollow spike to be fluidly connected to the internal void.

20. (canceled)

21. The fluid dispenser of claims 16, wherein the fluid reservoir module further comprises:
a snapping tongue attached to the base,
wherein inserting the reservoir body into the lower chamber pushes the snapping tongue to engage a tongue receiver in the dispenser body.

22. The fluid dispenser of claims 16, wherein the fluid reservoir module further comprises:
a projecting arm attached to the top portion of the reservoir body, the projection arm partially extending into the lower chamber wherein there are retaining beads attached to an interior surface of the dispenser body, and the retaining beads engage the projecting arm and restrict the projecting arm to slide between the retaining beads.

23. (canceled)

24. (canceled)

25. The fluid dispenser of claims 16, wherein there is a second hole through the hollow spike on the bulkhead.

26. The fluid dispenser of claims 16, further comprising a pump mechanism disposed in the upper chamber.

27. A fluid dispenser, comprising:
a dispenser body enclosing an interior, the dispenser body having blocking tips, wherein there are retaining beads attached to an interior surface of the dispenser body;
a bulkhead disposed in the dispenser body, dividing the interior into an upper chamber and a lower chamber;
a hollow spike attached to the bulkhead, the hollow spike enclosing a through hole and a second hole; and
a fluid reservoir module comprising:
a base,
ribs attached to the base,
a reservoir body hermetically sealing an internal void, the reservoir body having a top portion and a bottom portion, wherein the ribs have profiled inner forms, the bottom portion of the reservoir body has profiled surfaces, and the profiled inner forms match the profiled surfaces, allowing the reservoir body to fit to the ribs, the top portion of the reservoir body comprises an upper neck encircling a neck hole, the neck hole being sealed by a frangible membrane,
two removable tabs attached to the reservoir body, wherein the removable tabs have notches that engage the blocking tips, blocking inserting the reservoir body into the lower chamber, and removal of the removable tabs allows the insertion of the reservoir body into the lower chamber,
a snapping tongue attached to the base, wherein inserting the reservoir body into the lower chamber pushes the snapping tongue to engage a tongue receiver in the dispenser body, and
a projecting arm attached to the top portion of the reservoir body, the projection arm partially extending into the lower chamber,
wherein the retaining beads engage the projecting arm and restrict the projecting arm to slide between the retaining beads.

28. (canceled)

29. (canceled)

30. The fluid dispenser of claims 27, further comprising a pump mechanism disposed in the upper chamber.
